(19) United States
(12) Patent Application Publication
(10) Pub. No.: US 2008/0130558 A1
(43) Pub. Date: Jun. 5, 2008

(54) Acess Network Selection Method Using Multi-Criteria Decision Making In Mobile Heterogeneous Network

(76) Inventors: Jong-Chan Lee, Daejeon-city (KR); Soo-Chang Kim, Daejeon-city (KR); Pyeong-Jung Song, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 11/719,915

(22) PCT Filed: Dec. 7, 2005
(86) PCT No.: PCT/KR05/04182

§ 371 Date: May 22, 2007

(30) Foreign Application Priority Data
Dec. 7, 2004 (KR) 10-2004-0102423
Aug. 17, 2005 (KR) 10-2005-0075217

(51) Int. Cl. H04Q 7/00

(52) U.S. Cl. 370/329

(57) ABSTRACT

An access network selection system and method using a fuzzy multi-criteria decision making method under a heterogeneous network system are provided. With such a system and method, a subscriber selectively accesses an access network having advantageous communication quality and cost according to transmission environment and service characteristics so that mobility capability is increased due to effective utilization of radio resources and traffic division of heterogeneous access networks. In addition, an optimum access network can be selected using a membership function and a decision making function evaluating access network selection parameters for multi criteria decision-making. Therefore, the access network selection method using fuzzy multi-criteria decision making can ensure mobility and access network options for a subscriber and ensure effective management of a wireless infrastructure resource to a provider under a heterogeneous network environment.

### TECHNICAL FIELD

The present invention relates to an access network selection method using fuzzy multi-criteria decision making, and more particularly to an access network selection method using fuzzy multi-criteria decision making in resource management technology for next generation mobile communication.

### BACKGROUND ART

4G mobile communication system is referred to as a next generation mobile communication system, the next generation mobile communication system a harmoniously cooperates with 2G/3G and 4G mobile communication systems as well as a wireless local area network (WLAN) or Bluetooth of the conventional 802 series. The next generation mobile communication system uses one wireless access network at a hot-spot area and uses cooperated conventional systems at areas other than the hot-spot area so as to provide high-speed data communication instead of using the same wireless access network at every area so that it may provide an optimum service for a mobile terminal regardless of location thereof.

Accordingly, the next generation mobile communication system requires supporting a handover between heterogeneous systems such that it provides a seamless service for the mobile user just as when the mobile terminal moves under a ubiquitous environment in which multiple wireless communication systems are hierarchically used. In order to support such a handover among hierarchically heterogeneous systems, a QoS management structure that is capable of ensuring a user QoS based on End-to End agreed QoS information is required.

That is, the next generation mobile communication system is managed such that the terminal selects a desired access network under a hierarchically heterogeneous systems terminal. However, it is difficult to select an optimum access network for performing a predetermined service at a predetermined time and location, because all access networks have respective system characteristics and functions.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide an access network selection method using fuzzy multi-criteria decision making having advantages of ensuring an advantageous quality of service and communication cost to subscribers (or users) and ensuing effective management of a wireless infrastructure resource and traffic distribution of heterogeneous access networks to providers by selecting an optimum access network considering a plurality of access network selection parameters of users and providers using multi-criteria decision making with fuzzy operators under global integrated network environment.

### Technical Solution

An exemplary access network selection method according to an embodiment of the present invention provides a service from an application service provider to the user on heterogeneous networks formed with heterogeneous systems performed by different protocols. The access network selection method comprises (a) selecting access networks based on access network selection parameters satisfying basic condition that the application service provider determines considering context information formed with the user information and terminal information; and (b) selecting an optimum access network from the selected access networks by performing a main selection process using the multi-criteria fuzzy decision making scheme having a predetermined access network selection policy to determine a priority order of the access network selection parameters concerning user information and system information.

At this time, (b) selecting an optimum access network from the selected access networks may be performed by (1) determining a decision matrix and weighting vector for applying the access network selection parameters, (2) selecting access network selection parameter levels considering the access network selection policy, (3) determining membership function values and fuzzy membership levels for the access network selection parameters and the access network selection policy, (4) determining weighted function values for the access network selection values, (5) determining access network selection priority orders by determining generalized mean values from the determined membership levels of the weighted membership functions, and (6) selecting an access network by the determined access network selection priority order.

### BRIEF DESCRIPTION OF THE DRAWINGS

FIG. 1 illustrates access network selection parameters classified by a classification policy according to an exemplary embodiment of the present invention.

FIG. 2 is a flowchart showing a first selection process of an access network according to an exemplary embodiment of the present invention.

FIG. 3 illustrates a membership function of language variables for a decision matrix according to an exemplary embodiment of the present invention.

FIG. 4 illustrates a membership function of language variables for a weight vector according to an exemplary embodiment of the present invention.

### MODE FOR THE INVENTION

An exemplary embodiment of the present invention will hereinafter be described in detail with reference to the accompanying drawings.

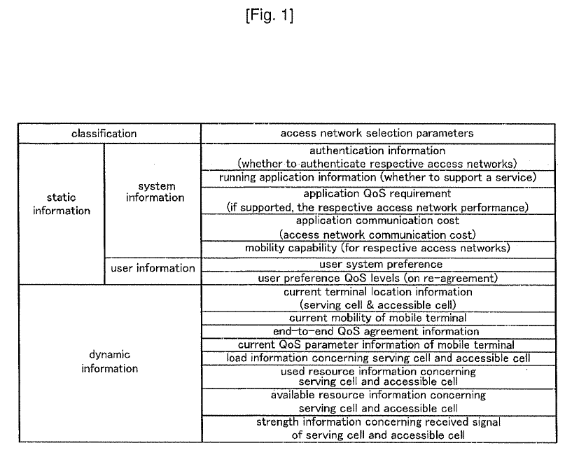

FIG. 1 shows access network selection parameters classified by a classification policy according to an exemplary embodiment of the present invention.

As shown in FIG. 1, access network selection parameters for selecting an access network are previously agreed between a mobile terminal and an access network, and are classified into invariable static information and periodically variable dynamic information according to states of the mobile terminal and the access network. The static information includes SLA (Service Level Agreement) information, and the dynamic information includes the mobile terminal location information or the access network state information.

The static information may be classified into system information and user information. The system information relates to the mobile terminal and the user information relates to the user who uses multimedia services.

The system information may include authentication information of the access network that the mobile terminal may access, a type of application that the mobile terminal may perform, respective application QoS requirements, respective application communication costs, and mobile terminal mobility capabilities. In addition, the user information may include access network preference information regarding the access network that the user often accesses, and user preference QoS level information regarding the applications for providing a service. The user preference QoS level information is used on re-agreement of the access network.

The dynamic information may include current location information of the mobile terminal, serving application QoS parameter information, and available resource information regarding the serving access network and the accessible access networks.

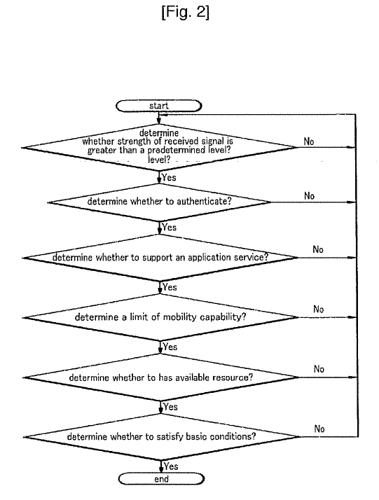

The access network may be selected based on the information of FIG. 1. FIG. 2 is a flowchart showing a first selection process of an access network according to an exemplary embodiment of the present invention.

Referring to FIG. 2, basic conditions are selected based on the information of FIG. 1. The basic conditions are required such that the mobile terminal may access a predetermined access network. The access network will be firstly selected according to such basic conditions. The basic conditions include strength of the received signals, the authentication states, the supporting state of services, the mobile terminal mobility capabilities, and the state of available resources.

First, when the mobile terminal receives the signals from some access systems, it is determined whether the strength of the received signals are greater than a predetermined level, which is previously provided (S200). When the strength of the received signals are greater than the predetermined level, it is determined whether the access networks are authenticated such that the mobile terminal can access the access networks (S210). When the mobile terminal can use the access network, it is determined whether application services are supported (S220).

When the desired application services can be supported by the access network, the mobility capabilities of the mobile terminal are determined (S230). When the access network can provide the desired application service even at the limit of the mobility capability, it is determined whether the access network has available resources (S240). When the access network has available resources, it is determined whether the access network has satisfied basic conditions that the mobile terminal requires (S250).

At this time, the mobile terminal can access any access network among a plurality of access networks selected through the above processes. When the access network has not satisfied any basic conditions, the access network cannot be used.

In order to select an optimum access network among the plurality of access networks satisfying the basic conditions of the first selection process, a second selection process is required. The second selection process is given as a main selection process. The access network selection parameters for performing the second selection process include the user information such as the communication cost, the system preference and user preference QoS based on E2E (End-to-End) QoS, and the system information such as access network load. The optimum access network is selected when the communication cost is minimized, the device preference is maximized, the user preference QoS based on E2E QoS is maximized, and the access network load is minimized.

The access network selection parameters are divided into the user information and the system information, and a priority order of the access network selection parameters is determined by a predefined access network selection policy. The predefined access network selection policy may control weighting values allocated to the access network selection parameters, and thus an access network selection list that can be selected among the plurality of access networks is dynamically updated.

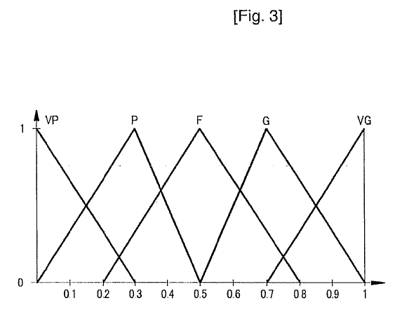

FIG. 3 shows a membership function of language values for a decision matrix according to an exemplary embodiment of the present invention. The membership function shows how the access network selection parameters are used to select an optimum access network during the second selection process.

During this second selection process, a decision-making function is determined to obtain the access network parameters. The decision-making functions A₁(i=1,2, . . . n) for the respective network selection parameters are defined as alternates obtained using the access network selection parameter Cⱼ(j=1,2, . . . m). A decision-making function X for expressing how much the respective alternatives satisfies access network selection conditions is given as Equation 1.

$$X = [ \begin{matrix}{x}_{11} & {x}_{12} & … & {x}_{1 m} \\ {x}_{21} & {x}_{22} & … & {x}_{2 m} \\ {x}_{31} & {x}_{32} & … & {x}_{3 m} \\ {x}_{41} & {x}_{42} & … & {x}_{4 m} \\ … & … & … & … \\ {x}_{n 1} & {x}_{n 2} & … & {x}_{n m}\end{matrix} ] \qquad ( Equation 1 )$$

In Equation 1, xᵢⱼ indicates linguistic decision results, and the linguistic decision results will hierarchically estimate the alternatives Aᵢ(i=1, 2, . . . n) having the access network selection parameter Cⱼ(j=1, 2, . . . m). The x is expressed by a set of language variables such as VP (Very Poor), P (Poor), F (Fair), G (Good), and VG (Very Good). A membership function of the language variables is used in the decision matrix as shown in FIG. 3.

As described above, when the decision matrix is determined to obtain the access network selection parameters, weighting vectors are determined with respect to the respective access network selection parameters. The weighting vector W is given as Equation 2.

W=(w₁, w₂, . . . , wₘ) (Equation 2)

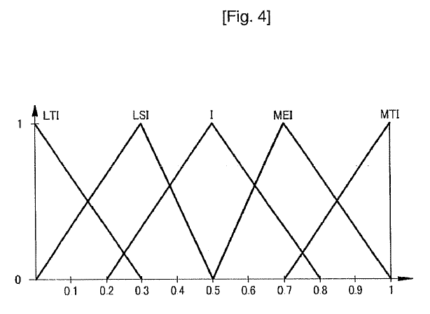

In Equation 2, wⱼ is given as a fuzzy weight of the access network selection parameter Cⱼ(j=1, 2, . . . m). The wj is expressed by a set of langue variables such as LTI (Least important), LSI (Less important), I (Important), MEI (More important), and MTI (Most important). According to an exemplary embodiment of the present invention, the membership functions of these language variables are expressed in the same manner as a membership function with respect to the weighting vectors shown in FIG. 4.

When the weighting vectors are determined for the respective access network selection parameters, respective selection parameter levels are selected for the access network selection policy. The respective selection parameter levels for the access network selection policy are defined as in Table 1. The respective access network selection parameters are established from a level 1 to a level 6. These respective levels have appropriately allocated numbers.

It will be known that in the case of the communication cost, the allocated number has a highest value when the selection parameter is given as the lowest level 1, since the level 1 expresses the most minimized communication cost so that the access network satisfies the selection condition of which the communication cost is minimized. Also, it will be known that in the case of the user system preference, the allocated number has a highest value when the selection parameter is given as the lowest level 1, since the level 1 expresses the maximized system preference so that the access network satisfies the selection condition of which the user system preference is maximized.

TABLE 1

| Access Network | Access Network | | |
|---|---|---|---|
| Selection Parameter | Selection Level | Language Expression | Allocated Number |
| Communication | C₁ | Very Cheap | 10 |
| Cost (C) | C₂ | Cheap | 6 |
| | C₃ | Moderate | 3 |
| | C₄ | More or less | 1 |
| | | Expensive | |
| | C₅ | Expensive | 0.5 |
| | C₆ | Very Expensive | 0.2 |
| User's System | P₁ | Most Preferable | 10 |
| Preference (P) | P₂ | More Preferable | 6 |
| | P₃ | Preferable | 3 |
| | P₄ | Moderate | 2 |
| | P₅ | Hateful | 1 |
| | P₆ | Very Hateful | 0.5 |
| User's QoS(Q) | Q₁ | Most Superior | 10 |
| Preference based | Q₂ | Very Superior | 8 |
| on End-to-End QoS | Q₃ | Superior | 5 |
| | Q₄ | Moderate | 2 |
| | Q₅ | More or less Inferior | 1 |
| | Q₆ | Inferior | 0.5 |
| Access Network | L₁ | Smallest | 10 |
| Load(L) | L₂ | Small | 6 |
| | L₃ | Moderate | 3 |
| | L₄ | More or Less Large | 1 |
| | L₅ | Heavy | 0.5 |
| | L₆ | Heaviest | 0.2 |

When the respective selection parameter levels are selected for the access network selection policy as described above, the membership function values are determined for the access network selection policy and the access network selection parameter levels as Table 2. The membership order values for expressing how strong it is may be classified into L (Low), M (Medium), MLH (More or Less high), H (High), VH (Very High), which respectively include values appropriate for the access network selection levels of the respective access network selection parameters.

When the membership function values are determined for the access network selection parameter levels as Table 2, fuzzy membership levels are determined for the respective access network selection policy and the access network selection parameters. The membership levels for the respective access network selection parameters are calculated in Equation 3.

TABLE 2

| Access | Access | | | | | |
|---|---|---|---|---|---|---|
| Network | Network | Membership | | | | |
| Selection | Selection | Function Values | | | | |
| Parameter | Level | L | M | MLH | H | VH |
| Communication | C₁ | 0 | 0 | 0 | 0.5 | 1.0 |
| Cost (C) | C₂ | 0 | 0 | 0.5 | 1.0 | 0.5 |
| | C₃ | 0 | 0.3 | 0.7 | 0.5 | 0 |
| | C₄ | 0 | 0.3 | 0.5 | 0 | 0 |
| | C₅ | 0.5 | 0.5 | 0 | 0 | 0 |
| | C₆ | 1.0 | 0 | 0 | 0 | 0 |
| User's | P₁ | 0 | 0 | 0 | 0.5 | 1.0 |
| System | P₂ | 0 | 0 | 0.5 | 1.0 | 0.5 |
| Preference | P₃ | 0 | 0.5 | 1.0 | 0.5 | 0 |
| (P) | P₄ | 0 | 0.5 | 0.5 | 0 | 0 |
| | P₅ | 0.5 | 0.5 | 0 | 0 | 0 |
| | P₆ | 1.0 | 0 | 0 | 0 | 0 |
| User's QoS | Q₁ | 0 | 0 | 0 | 0 | 1.0 |
| (Q) | Q₂ | 0 | 0 | 0 | 1.0 | 0.5 |
| Preference | Q₃ | 0 | 0.5 | 1.0 | 0.5 | 0 |
| based on | Q₄ | 0 | 0.5 | 0.5 | 0 | 0 |
| End-to-End | Q₅ | 0.5 | 0.5 | 0 | 0 | 0 |
| QoS | Q₆ | 1.0 | 0 | 0 | 0 | 0 |
| Access | L₁ | 0 | 0 | 0 | 0 | 1.0 |
| Network | L₂ | 0 | 0 | 0 | 1.0 | 0.5 |
| Load(L) | L₃ | 0 | 0.5 | 1.0 | 0.5 | 0 |
| | L₄ | 0 | 0.5 | 0.5 | 0 | 0 |
| | L₅ | 0.5 | 0.5 | 0 | 0 | 0 |
| | L₆ | 1.0 | 0 | 0 | 0 | 0 |

$${R}_{ij} = \frac{1}{{\sum }_{n} {P}_{ijn}} ⊗ [ {( + )}_{n = L}^{VH} {R}_{ijn} ⊕ {P}_{ijn} ] \qquad ( Equation 3 )$$

In Equation 3, i is given as an access network selection policy, j is given as an access network selection parameter, n is given as a language variable for expressing a membership level, Rijn is given as a fuzzy number for the access network selection policy i and the access network selection parameter level j, and Pijn is given as a membership function value for the access network selection policy i and the access network selection parameter level j.

Next, weighted membership function values for the access network selection policy are determined considering relative importance along with the calculated membership levels of the access network selection parameters. A weighted averaging method is used to integrate the membership levels of the respective access network selection parameters. The weighted membership levels of the access network selection policy are calculated in Equation 4.

$${F}_{i} = \frac{1}{4} [ {( + )}_{j = L}^{C} {R}_{ij} ⊗ {W}_{j} ] j ∈ \{ C , P , Q , L \} \qquad ( Equation 4 )$$

In Equation 4, Rᵢⱼ is given as a fuzzy number of the access network selection policy i and the access network selection parameter j relative to the membership levels and Wⱼ is given as a fuzzy importance for the access network selection parameter j. In this case, it is defined as Rᵢⱼ=(oᵢⱼ, pᵢⱼ, qᵢⱼ, rᵢⱼ), Wⱼ=(aⱼ, bⱼ, cⱼ, dⱼ).

The general fuzzy selection policy estimating value Fᵢ of the access network selection policy i is defined as Fᵢ (Aᵢ, Bᵢ, Cᵢ, Dᵢ), and respective fuzzy selection policy estimate parameters (Aᵢ, Bᵢ, Cᵢ, Dᵢ) are calculated using an approximation formula such as Equations 5 to 8, that is, trapezoid fuzzy values operated by Equation 2.

$$\begin{matrix}{A}_{i} = {\sum }_{j = L}^{C} \frac{{o}_{ij} \cdot {a}_{j}}{4} & ( Equation 5 ) \\ {B}_{i} = {\sum }_{j = L}^{C} \frac{{p}_{ij} \cdot {b}_{j}}{4} & ( Equation 6 ) \\ {C}_{i} = {\sum }_{j = L}^{C} \frac{{q}_{ij} \cdot {c}_{j}}{4} & ( Equation 7 ) \\ {D}_{i} = {\sum }_{j = L}^{C} \frac{{r}_{ij} \cdot {d}_{j}}{4} & ( Equation 8 )\end{matrix}$$

When the weighted membership function values are determined as described above, a priority order of the membership levels for the access network selection policy is determined using a Generalized Mean Value (GMV) method such that a fuzzy set of the membership levels is prioritized. GMV for the weighted membership levels Fi is given as Equation 9.

$$m ( {F}_{i} ) = \frac{{( {C}_{i} + {D}_{i} )}^{2} - {( {A}_{i} + {B}_{i} )}^{2} + {A}_{i} \cdot {B}_{i} - {C}_{i} \cdot {D}_{i}}{3 \cdot [ ( {C}_{i} + {D}_{i} ) - ( {A}_{i} + {B}_{i} ) ]} \qquad ( Equation 9 )$$

When the membership level has a large GMV, the access network corresponding to the membership level is selected because a large GMV has a higher priority order than that of the membership levels having a small GMV on the selection of the access network.

The access network selection method using fuzzy multi-criteria decision making according to an exemplary embodiment of the present invention has an advantage in that it is capable of ensuring mobility and an access network option to a subscriber and ensuing effective management of a wireless infrastructure resource to a provider under a heterogeneous network environment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An access network selection method using the multi-criteria fuzzy decision making scheme for providing services from the application service providers to the users on heterogeneous networks formed with heterogeneous systems performed by different protocols, the access network selection method comprising:
(a) selecting access networks based on access network selection parameters satisfying basic condition parameters that the application service provider determines considering context information formed with user information and terminal information; and
(b) selecting an optimum access network from the selected access networks by performing a main selection process using a multi-criteria fuzzy decision making scheme having a predetermined access network selection policy to determine a priority order of the access network selection parameters concerning user information and system information.

2. The access network selection method of claim 1, wherein the access network parameters include static information and dynamic information provided between the mobile terminal and the access network.

3. The access network selection method of claim 2, wherein the static information includes system information such as authentication information of the access network, performable application types, application QoS requirement levels, communication cost levels, mobile terminal mobility capability, and user information such as an access network preference of user using the mobile terminal and application preference QoS levels.

4. The access network selection method of claim 1, wherein at step a), the basic condition parameters include strength of a received signal of the mobile terminal, a authentication state of the access network, a supporting state of the application service, a mobility capability, and available resource state of the access network.

5. The access network selection method of claim 1, further comprising at step b):
(1) determining a decision matrix and weighting vector applicable to the access network selection parameters;
(2) selecting access network selection parameter levels considering the access network selection policy;
(3) determining membership function values and fuzzy membership levels for the access network selection parameters and the access network selection policy;
(4) determining weighted membership function values for the access network selection values;
(5) determining access network selection priority order by determining generalized mean values from the determined membership levels of the weighted membership functions; and
(6) selecting an access network by the determined access network selection priority order.

6. The access network selection method of claim 5, wherein the access network selection parameters include a communication cost, a user system preference, an access network load, and a user's QoS preference based on End-to-End QoS.

7. The access network selection method of claim 5, wherein the fuzzy membership levels are calculated by the access network selection policies, the access network selection parameters, language variables for expressing the membership levels, fuzzy numbers for the access network selection policies and the access network selection parameter levels, and membership function values for the access network selection policies and the access network selection parameter levels.

8. The access network selection method of claim 5, wherein the weighted membership function values for the access network selection policies are calculated by fuzzy numbers for the access network selection policies and the access network selection parameter levels, and a fuzzy importance for the access network selection parameters.

9. The access network selection method of claim 5, wherein a decision matrix expressed by a set of language variables such as VP (Very Poor), P (Poor), F (Fair), G (Good) or VG (Very Good) is used to determine the decision-making functions.

10. The access network selection method of claim 5, wherein weighting vectors are expressed by a set of language variables such as LTI (Least Important), LSI (Less Important), I (Important) MEI (More Important), or MTI (Most Important).
